(19) United States
(12) Patent Application Publication
(10) Pub. No.: US 2011/0140591 A1
(43) Pub. Date: Jun. 16, 2011

(54) Single multi-facet light source LED bracket

(76) Inventor: Han-Ming Lee, Hsinchu City (TW)

(21) Appl. No.: 12/653,371

(22) Filed: Dec. 14, 2009

(51) Int. Cl. H01J 5/50

(52) U.S. Cl. 313/318.05

(57) ABSTRACT

The present invention relates to a single multi-facet light source LED bracket and in particular to one that departs from the traditional structure of single spot gathering chip cup lighting, the main improvements including: the epoxy resin or silicon cover is provided with 2 to 3 sets of positive/negative conducting brackets opposite to each other, the side of the left/right conducting brackets extend to present a trapezoidal block surface for fastening 3 equally spaced chips connected in series for lighting. The central conducting bracket extends upward to present a trapezoidal block surface and the design in which the 3 equally spaced chips are fastened and connected in series for upward lighting. The structure is provided to achieve the industrial application of a single multi-facet uniform lighting source LED bracket.

### BACKGROUND OF THE INVENTION

The lighting principle of the LED bulb is that the chips are built inside the chip cup above the bracket and a circuit board is welded below the bracket to input power and generate the light source. When the structure is actually used for the high power chips, the effect of serious high temperature accumulated due to being energized for a long period results in premature optical decay of the chips, reducing the luminance of the light and shortening the service life of the chips.

### SUMMARY OF THE INVENTION

The primary purpose of the present invention is to provide a single multi-facet light source LED bracket and in particular to one in which the epoxy resin or silicon cover is provided with 2 to 3 sets of positive/negative conducting brackets opposite to each other for fastening of a plurality of chips on the left, on the right and at the top to provide multi-facet uniform light source.

The secondary purpose of the present invention is to provide a single multi-facet light source LED bracket and in particular to one in which the side of the left/right conducting brackets and the central conducting bracket extend upward to present a trapezoidal block surface for fastening 3 equally spaced chips connected in series for lighting so as to alleviate the optical decay resulted from deficiency of high temperature and high power of traditional single chip.

Another purpose of the present invention is to provide a single multi-facet light source LED lamp, wherein the bottom of one of the conducting brackets is designed into a wide plate surface so that the heat at the top may be transferred downward to double the radiating surface.

### BRIEF DESCRIPTION OF THE DRAWINGS

FIG. 1 is a 3D diagram of the present invention.

FIG. 2 is a schematic diagram of the components of the present invention.

FIG. 3 is a side view of the 3-side lighting function of the present invention.

FIG. 4 is a schematic of the traditional structure.

FIG. 5 is a schematic of another embodiment of the present invention.

FIG. 6 is a decomposition schematic of the components of another embodiment of the present invention.

### DETAILED DESCRIPTION OF THE PREFERRED EMBODIMENT

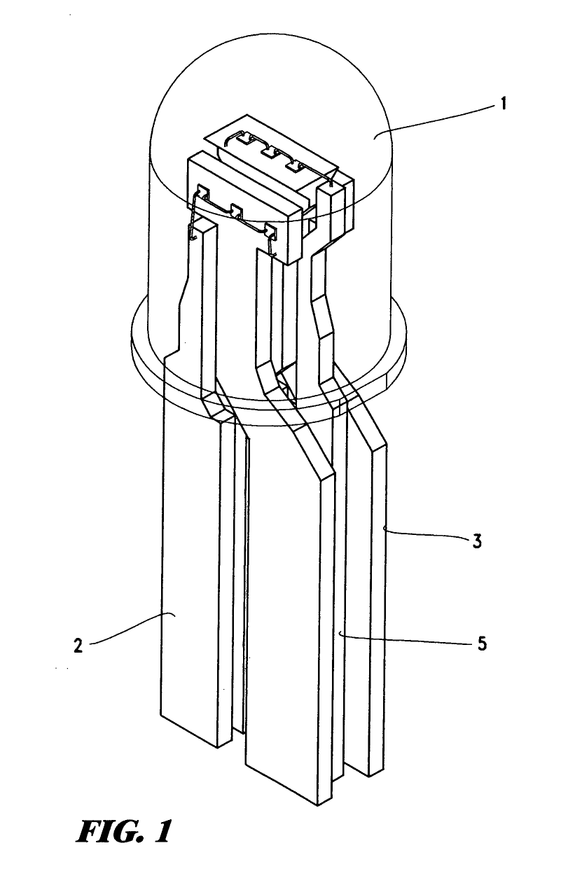

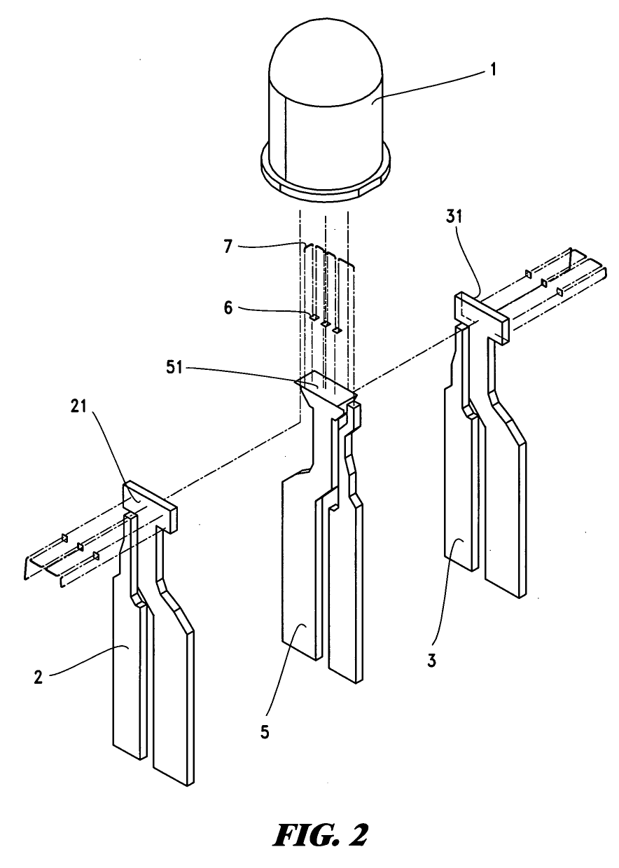

Please refer to FIGS. 1 through FIGS. 4. The present invention relates to a single multi-facet light source LED bracket, comprising the silicon cover 1, conducting brackets 2, 3 and 5, chip 6 and conducting wire 7; the silicon cover 1 is a light-transmitting material made of epoxy resin or silicon injection sealing the conducting brackets 2, 3 and 5, chip 6 and conducting wire 7; the conducting brackets 2, 3 and 5 are a positive/negative conducting bracket, the upper side of the left/right conducting brackets and the upper end of the central conducting bracket extend to present trapezoidal block surfaces 21, 31, 51 respectively; the chip 6 is a lighting semi-conductor chip for embedding into the trapezoidal block surfaces 21, 31 and 51 for equally spaced distribution, serial connection and fastening; the conducting wire 7 is a wire made of conducting material with its two ends available for serial connection of the chips 6, positive/negative conducting brackets 2, 3 and 5.

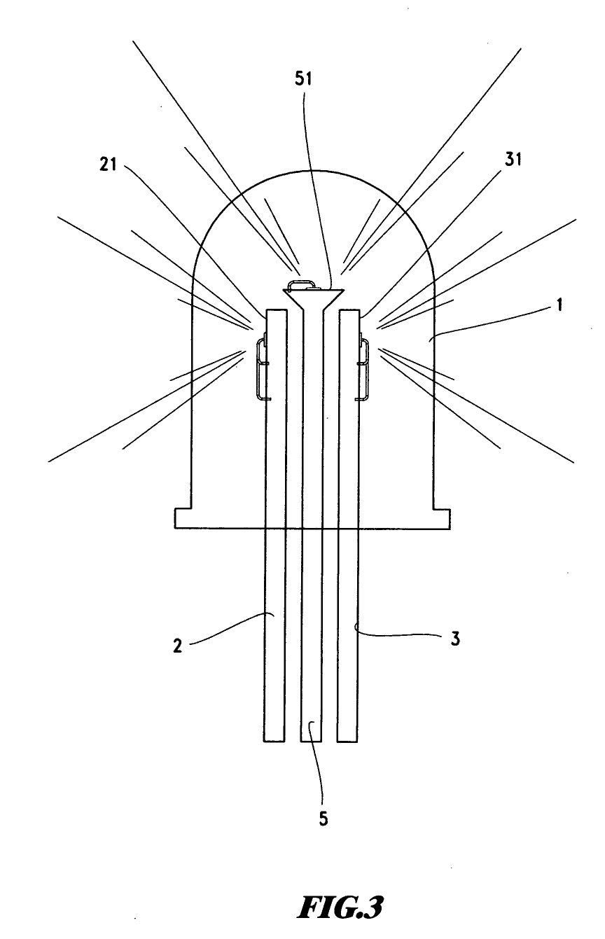

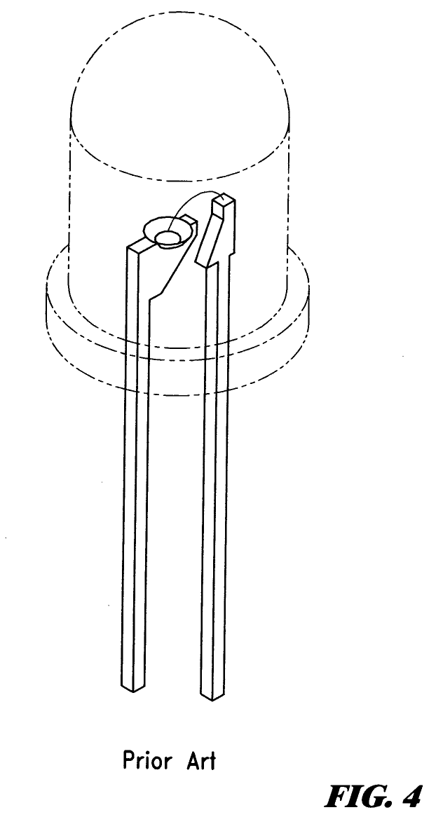

Please refer to FIG. 3 through FIG. 4 for the embodiment of the present invention. The silicon cover 1 is provided with 3 sets of positive/negative conducting brackets 2, 3 and 5 opposite to each other, the side of the left/right conducting brackets 2 and 3 extends to present trapezoidal block surfaces 21 and 31 for equally spaced distribution, fastening, serial connection and lighting of the 3 chips 6; the central conducting bracket 5 extends upward to present a trapezoidal block surface 51 for equally spaced distribution, fastening, serial connection and lighting of the 3 chips 6 to achieve the industrial application of single multi-facet uniform light source LED bracket.

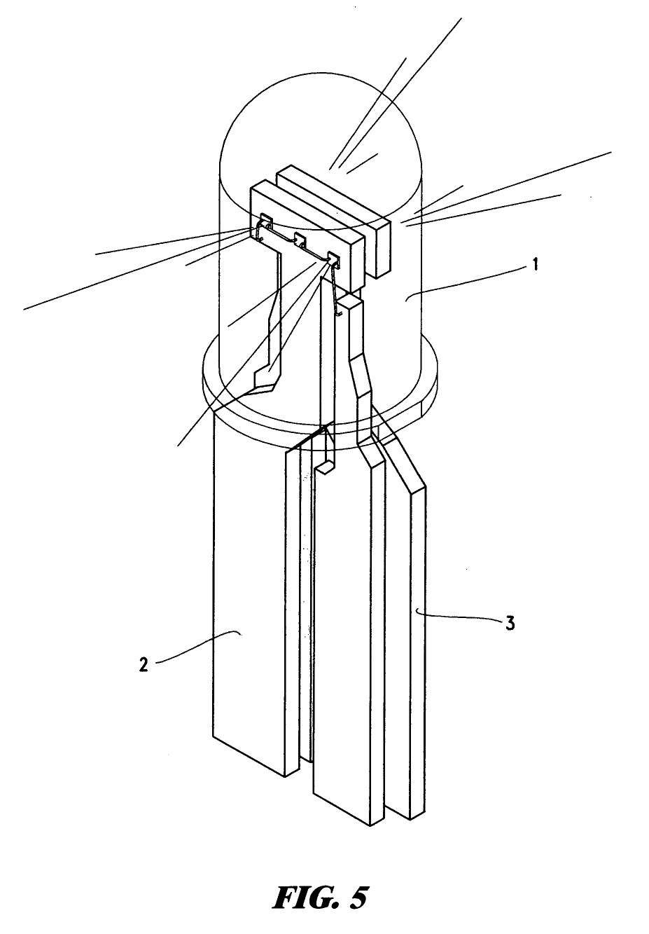

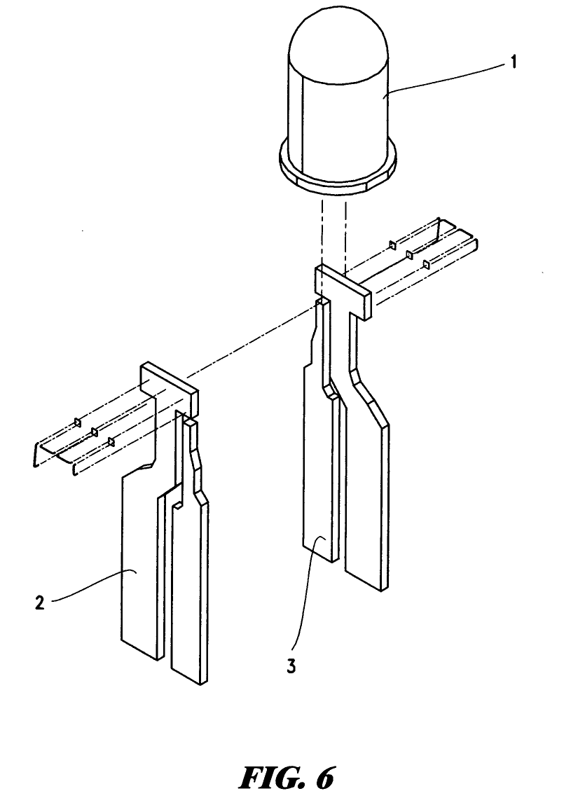

Please refer to FIG. 5 and FIG. 6 for another embodiment of the present invention. The silicon cover 1 may be reduced to be provided with 2 sets of left and right positive/negative conducting brackets 2 and 3 opposite to each other so that the side of the left/right conducting brackets 2 and 3 extends to present trapezoidal block surfaces 21 and 31 for equally spaced distribution, fastening, serial connection and lighting of the 3 chips 6 to provide the efficiency of variant combinations of lighting sources of different function requirements.

I claim:

1. A single multi-facet light source LED bracket, comprising the silicon cover, conducting brackets, chip and conducting wire, its main improvement in the silicon cover is provided with 3 sets of positive/negative conducting brackets opposite to each other, the side of the left/right conducting brackets extends to present a block surface for equally spaced fastening, serial connection and lighting of the plurality of chips; The central conducting bracket extends upward to present a trapezoidal block surface and the design in which the plurality of equally spaced chips are fastened and connected in series for upward lighting is provided to achieve the industrial application of a single multi-facet uniform lighting source LED bracket.

2. The single multi-facet light source LED bracket according to claim 1, wherein the epoxy resin or silicon cover may be reduced to be provided with 2 sets of left/right positive and negative conducting brackets opposite to each other to provide the efficiency of variant combinations of lighting sources of different function requirements.
